(19) United States
(12) Patent Application Publication
(10) Pub. No.: US 2025/0053690 A1
(43) Pub. Date: Feb. 13, 2025

(54) METHOD AND SYSTEM FOR MANAGING DIGITAL EVIDENCE USING A BLOCKCHAIN

(71) Applicant: Thomson Reuters Enterprise Centre Gmb, Zug (CH)

(72) Inventor: Paul SACHS, West Sussex (GB)

(21) Appl. No.: 18/929,604

(22) Filed: Oct. 28, 2024

Related U.S. Application Data
(63) Continuation of application No. 17/258,895, filed on Jan. 8, 2021, now Pat. No. 12,153,717.

(30) Foreign Application Priority Data
Jul. 10, 2018 (GB) 1811263.1

(51) Int. Cl. G06F 21/64; G06F 21/10; G06F 21/60; H04L 9/00; H04L 9/32

(52) U.S. Cl. CPC G06F 21/64; G06F 21/10; H04L 9/3239; G06F 21/60; H04L 9/3297; H04L 9/50

(57) ABSTRACT

A computer-implemented method and system for managing digital evidence using a blockchain. The method comprises receiving an evidence data file, the evidence data file being identified by: an evidence identifier, and a hash code computed from the evidence data file; generating a block for the blockchain by combining data indicative of: a hash of a previous block in the blockchain, the evidence identifier, and the hash code computed from the evidence data file; and storing the generated block as a new block in the blockchain, wherein the method further comprises: outputting at least part of the data in the blockchain in response to a user request to enable a user to verify the authenticity of the evidence data file using the data in the blockchain.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent is a continuation from U.S. application Ser. No. 17/258,895, filed Jan. 8, 2021, entitled “A METHOD AND SYSTEM FOR MANAGING DIGITAL EVIDENCE USING A BLOCKCHAIN”, which claims priority from International PCT Patent Application No. PCT/GB2019/051851, filed Jun. 28, 2019 entitled, “A METHOD AND SYSTEM FOR MANAGING DIGITAL EVIDENCE USING A BLOCKCHAIN”, which claims priority to United Kingdom Application No. 1811263.1, filed Jul. 10, 2018, all of which are incorporated herein by reference in their entirety.

### BACKGROUND

The present invention relates to a method and system for managing digital evidence using a blockchain. The present invention more particularly relates to a method and system for enabling a user to verify the authenticity of evidence using the blockchain.

In a typical court case there is a large volume of evidence which must be collated and presented to the court. Traditionally this evidence was submitted in the form of paper bundles but nowadays evidence is often provided electronically in the form of electronic documents, images, sound recordings or video recordings.

The problem with electronic evidence is that it is not possible to be certain that the evidence presented by a system is identical to the evidence that has been loaded into the system. For instance, a user cannot be absolutely sure that a piece of electronic evidence has not been tampered with in some way to change the meaning or weight of the evidence.

In the case of video evidence, it can be extremely difficult to detect whether the content of the video file has been edited. For instance, a video could have been edited to remove the word “not” from a portion of the video footage to completely change the meaning of the evidence.

A similar problem arises for digital image evidence where it can be very difficult to detect whether an image has been edited, for instance to remove an object or a person from the image.

The problem can also arise with electronic documents, where it is difficult and time consuming to check an electronic document for tampering (e.g. by removing or changing words). The task becomes almost impossible for large cases where there can be a very large number of pages of evidence (e.g. 250,000+ pages).

There is a need for a method and system for managing digital evidence which alleviates at least some of the problems described above.

### SUMMARY

The present invention seeks to provide an improved method and system for managing digital evidence using a blockchain.

According to one aspect of the present invention, there is provided a computer-implemented method for managing digital evidence using a blockchain, the method comprising: receiving an evidence data file, the evidence data file being identified by: an evidence identifier, and a hash code computed from the evidence data file; generating a block for the blockchain by combining data indicative of: a hash of a previous block in the blockchain, the evidence identifier, and the hash code computed from the evidence data file; and storing the generated block as a new block in the blockchain, wherein the method further comprises: outputting at least part of the data in the blockchain in response to a user request to enable a user to verify the authenticity of the evidence data file using the data in the blockchain.

Preferably, the method further comprises: assigning the evidence identifier to the evidence data file; and computing the hash code from the evidence data file.

Conveniently, the method further comprises: performing a transformation operation on the evidence data file to produce a transformed evidence data file; generating the block for the blockchain by further combining data indicative of: the transformation operation, and a timestamp indicating the time at which the transformation operation was performed, wherein the method further comprises: outputting at least part of the data in the blockchain in response to a user request to enable a user to verify the authenticity of the transformed evidence data file using the data in the blockchain.

Advantageously, the method further comprises: performing a plurality of transformation operations on the evidence data file to produce the transformed evidence data file.

Preferably, each transformation operation comprises converting an evidence data file document into a Portable Document Format (PDF) file.

Conveniently, the method further comprises combining at least one page from the evidence data file with at least one page from a further evidence data file and generating a paginated evidence data file in which each page of the file carries a page number.

Advantageously, the method further comprises: performing an image transformation operation on at least part of the evidence data file to generate a transformed evidence data file in the form of an image file which, when decoded and viewed on a display screen, represents the appearance of at least part of the evidence data file.

Preferably, the method comprises generating a first image file and a second image file, wherein the image resolution of the first image file is lower than the image resolution of the second image file.

Conveniently, the method further comprises: decoding and displaying each generated image file in response to a request from a user.

Advantageously, the method further comprises: displaying an authenticity indicator to a user with each image file, the authenticity indicator being indicative of data in the blockchain to notify a user viewing the authenticity indicator that the image file is verified as authentic by the data in the blockchain.

Preferably, the method further comprises: storing the evidence data file and the or each transformed evidence data file in a secure memory, the secure memory being configured to minimise or prevent an unauthorised user from accessing the evidence data file and each transformed evidence data file.

Conveniently, the method comprises receiving a plurality of evidence data files and repeating the steps of the method for each of the plurality of evidence data files.

According to another aspect of the present invention, there is provided a computer-implemented method for managing digital evidence using a blockchain, the method comprising: receiving a user request to verify the authenticity of an evidence data file, the evidence data file being identified by: an evidence identifier, and a hash code computed from the evidence data file; searching a blockchain for the evidence identifier; and if the evidence identifier is found in the blockchain, outputting an authenticity indicator to the user to notify the user that the evidence data file is verified as authentic by the data in the blockchain.

Preferably, the method further comprises: receiving a user request to access an evidence data file; outputting a transformed evidence data file to the user, the transformed evidence data file being a transformation of the evidence data file requested by the user and being identified by the same evidence identifier as the evidence data file requested by the user; and outputting the authenticity indicator to the user to verify the authenticity of the transformed evidence data file only if the evidence identifier is found the blockchain.

According to a further aspect of the present invention, there is provided a device or system comprising: a processor; and a memory and being configured to perform the method of any of the method claims as defined hereinafter.

According to another aspect of the present invention, there is provided a computer program having instructions which, when executed by a computing device or system, cause the computing device or system to perform the method of any of the method claims as defined hereinafter.

According to another aspect of the present invention, there is provided a data stream which is representative of a computer program according to claim 16 as defined hereinafter.

According to another aspect of the present invention, there is provided a computer readable medium storing instructions which, when executed by a computing device or system, cause the computing device or system to perform the method of any one of claims 1-14 as defined hereinafter.

### DRAWINGS

So that the present invention may be more readily understood, embodiments of the present invention will now be described, by way of example, with reference to the accompanying drawings, in which:

FIG. 1 is schematic diagram of a system of some embodiments,

FIG. 2 is a schematic diagram showing the operation of some embodiments with a blockchain, and

FIG. 3 is an example flow diagram indicative of the operation of a method of some embodiments.

### DETAILED DESCRIPTION

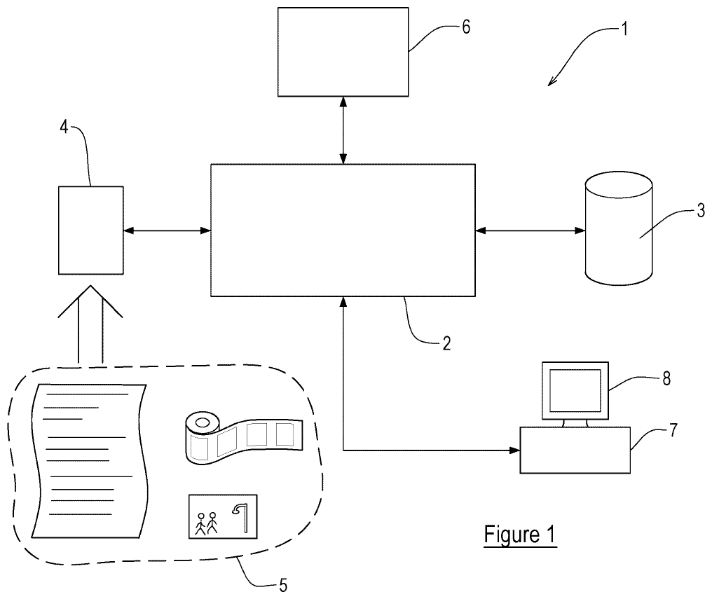

Referring initially to FIG. 1 of the accompanying drawings, a system 1 of some embodiment comprises a processor 2 and a memory 3 which is coupled for communication with the processor 2. In some embodiments, the processor 2 and the memory 3 are provided within a computing system, such as a server, or a plurality of networked computing systems or networked servers. The memory 3 stores instructions which, when executed by the processor 2, perform a method of some embodiments of the invention.

The system 1 further comprises an input module 4 which is coupled for communication with the processor 2. The input module 4 is configured to receive an evidence data file 5. The evidence data file 5 is an electronic data file which is selected from a group including, but not limited to, a document file, an image file, a sound file or a video file. The evidence data file may be in any data format, such as Microsoft Word™ or a Portable Document Format (PDF), a JPEG image format or an MPEG video format.

In some embodiments, the evidence data file 5 is a document file with a filetype selected from a group including, but not limited to: txt, att, rtf, doc, wbk, dot, docx, dotx, docm, dotm, htm, html, mht, odt, xml, xls, xlt, xla, xlsx, xltx, xlsm, xltm, xlam, xlsb, csv, pdf, ppt, pot, pps, ppa, pptx, potx, ppsx, pptm, potm, ppsm or msg.

In some embodiments, the evidence data file 5 is an image file with a filetype selected from a group including, but not limited to: bmp, png, gif, ico, jpg, jpeg, tiff or tif.

In some embodiments, the evidence data file 5 is an audio file with a filetype selected from a group including, but not limited to: aa, aac, aax, act, aiff, amr, ape, au, awb, dct, dss, dvf, flac, gsm, iklax, m4a, m4b, m4p, mmf, mp3, mpc, msv, ogg, oga, opus, raw, sln, tta, vox, way, wma or wv.

In some embodiments, the evidence data file 5 is a video file with a filetype selected from a group including, but not limited to: 264, 3g2, 3gp, 3gp2, 3gpp, 3gpp2, 3 mm, 3p2, 60d, 787, 89, aaf, aec, aep, aepx, aet, aetx, ajp, ale, am, amc, amy, amx, anim, anx, aqt, arcut, arf, asf, asx, avb, avc, avchd, avd, avi, avm, avp, avs, avv, awlive, axm, axv, bdm, bdmv, bdt2, bdt3, bik, bin, bix, bmc, bmk, bnp, box, bs4, bsf, bu, bvr, byu, camproj, camrec, camv, ced, cel, cine, cip, clk, clpi, cmmp, cmmtpl, cmproj, cmrec, cmv, cpi, cpvc, cst, cvc, cx3, d2v, d3v, dash, dat, day, db2, dce, dck, dcr, ddat, dif, dir, divx, dlx, dmb, dmsd, dmsd3d, dmsm, dmsm3d, dmss, dmx, dnc, dpa, dpg, dream, dsy, dv, dv-avi, dv4, dvdmedia, dvr, dvr-ms, dvx, dxr, dzm, dzp, dzt, edl, evo, exo, eye, eyety, ezt, f4f, f4p, f4v, fbr, fbz, fcarch, fcp, fcproject, ffd, ffm, fic, flh, fli, fly, fix, fpdx, ftc, g64, gcs, gfp, gifv, gl, gom, grasp, gts, gvi, gyp, gxf, h264, hdmov, hdv, hkm, ifo, imovielibrary, imoviemobile, imovieproj, imovieproject, inp, int, ircp, irf, ism, ismc, ismclip, ismv, iva, ivf, ivr, ivs, izz, izzy, jmv, jss, jts, jtv, k3g, kdenlive, kmv, ktn, lrec, lrv, lsf, lsx, lvix, m15, mlpg, mlv, m21, m2a, m2p, m2t, m2ts, m2v, m4e, m4u, m4v, m75, mani, meta, mgv, mj2, mjp, mjpeg, mjpg, mk3d, mky, mmv, mnv, mob, mod, modd, moff, moi, moov, mov, movie, mp21, mp2v, mp4, mp4infovid, mp4v, mpe, mpeg, mpeg1, mpeg2, mpeg4, mpf, mpg, mpg2, mpg4, mpgindex, mpl, mpls, mproj, mpsub, mpv, mpv2, mqv, msdvd, mse, msh, mswmm, mt2s, mts, mtv, mvb, mvc, mvd, mve, mvex, mvp, mvy, mxf, mxv, mys, ncor, nsv, ntp, nut, nuv, nyc, ogm, ogv, ogx, orv, osp, otrkey, pac, par, pds, pgi, photoshow, piv, pjs, playlist, plproj, pmf, pmv, pns, ppj, prel, pro, pro4dvd, pro5dvd, proqc, prproj, prtl, psb, psh, pssd, pva, pvr, pxv, qt, qtch, qtindex, qtl, qtm, qtz, r3d, red, rcproject, rcrec, rcut, rdb, rec, rm, rmd, rmp, rms, rmv, rmvb, roq, rp, rsx, rts, rum, rv, rvid, rvl, san, sbk, sbt, sbz, see, scm, sen, screenflow, sdv, see, sedprj, seq, sfd, sfera, sfvidcap, siv, smi, smil, smk, sml, smv, snagproj, spl, sqz, srt, ssf, ssm, stl, str, stx, svi, swf, swi, swt, tda3mt, tdt, tdx, theater, thp, tid, tivo, tix, tod, tp, tp0, tpd, tpr, trec, trp, ts, tsp, ttxt, tvlayer, tvrecording, tvs, tvshow, usf, usm, vbc, vel, vcpf, ver, vcv, vdo, vdr, vdx, veg, vem, vep, vf, vft, vfw, vfz, vgz, vid, video, viewlet, viv, vivo, vix, vlab, vmlf, vmlt, vob, vp3, vp6, vp7, vpj, vro, vs4, vse, vsp, vtt, w32, wcp, webm, wfsp, wgi, wlmp, wm, wmd, wmmp, wmy, wmx, wot, wp3, wpl, wsve, wtv, wve, wvx, wxp, xej, xel, xesc, xfl, xlmv, xmv, xvid, y4m, yog, yuv, zeg, zm1, zm2, zm3 or zmv.

In some embodiments, the input module 4 is configured to digitise an item of evidence into an evidence data file. For instance, in some embodiments, the input module 4 comprises a scanner which is configured to scan a paper document to digitise the paper document into an electronic data file.

In some embodiments, the input module 4 is provided at the same location as the processor 2. However, in other embodiments, the input module 4 is provided at a remote location from the processor 2 and configured to communicate with the processor 2 via a network, such as the Internet. In embodiments where the input module 4 is remote from the processor 2, the input module 4 can be situated at a location where it is desirable for a user to input an evidence data file into the system 1, such as at the offices of a law firm.

The evidence data file 5 is identified by an evidence identifier and a hash code computed from the evidence data file. The evidence identifier is a unique identifier within the system 1 which identifies the evidence data file 5, for instance in the form of an alpha numeric code. The hash code is computed from the evidence data file by processing the evidence data file with a hashing algorithm. In some embodiments, the hashing algorithm is selected from a group including, but not limited to, MD5, SHA-1, SHA-2, SHA-224, SHA-256, SHA-384, SHA-512, SHA-512/224, SHA-512/256, SHA-3, SHA3-224, SHA3-256, SHA3-384, SHA3-512, SHAKE128 or SHAKE256.

In some embodiments, the input module 4 or the processor 2 is configured to assign an evidence identifier to the evidence data file 5 and/or to compute a hash code from the evidence data file 5. In other embodiments, the system 1 receives an evidence data file 5 via the input module 4 with the evidence identifier and hash code already associated with the evidence data file 5.

The input module 4 transmits the evidence data file 5 and its associated evidence identifier and hash code to the processor 2.

The processor 2 is configured to communicate with a blockchain system 6. In some embodiments, the blockchain system 6 is integrated as a component or module within the system 1. In other embodiments, the blockchain system 6 is a remote system which is configured to communicate with the system 1 via a network, such as the Internet, with the processor 2. In further embodiments, the blockchain system 6 is a peer-to-peer network of computing devices which are operating as a decentralised, distributed digital ledger system.

In some embodiments, the blockchain system 6 is a public system which permits anyone to access the data in the blockchain. In other embodiments, the blockchain system 6 is a closed blockchain system which is only accessible to authorised users. In further embodiments, the blockchain system 6 is configured such that part of the data in the blockchain is accessible to the public and another part of the data in the blockchain is private and only accessible by authorised users.

The processor 2 is further configured for communication with a client computing system or device 7. In some embodiments, the processor 2 is configured to communicate via a network, such as the Internet, with the client computing device 7.

In some embodiments, the client computing device 7 comprises a screen 8 to display information to a user. The client computing device 7 is a device selected from a group including, but not limited to, a desktop computer, laptop computer or a mobile computing device, such as a tablet or smartphone.

The client computing device 7 may be positioned at the same location as the processor 2 or at a remote location. For instance, in some embodiments, the client computing device 7 is positioned in a courtroom for use by a judge during a trial. The client computing device 7 may equally be positioned at any other location, such as the offices of a law firm or at another location where it is desirable to view evidence which is being managed by the system 1.

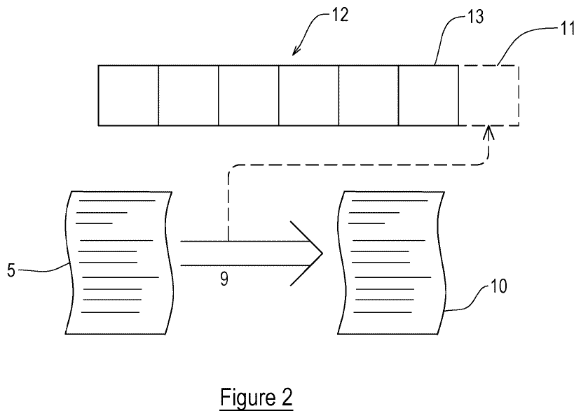

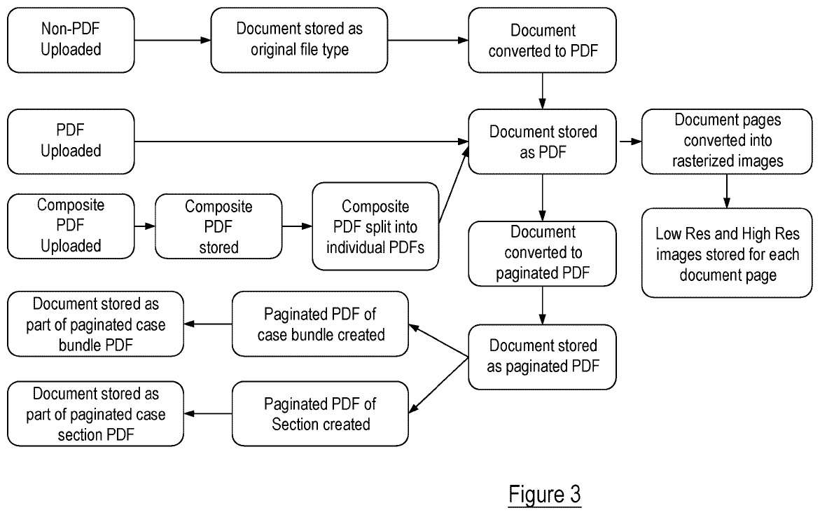

A method of managing digital evidence of some embodiments will now be described with reference to FIGS. 2 and 3 of the accompanying drawings.

An item of evidence is input into the system 1 via the input module 4. If the item of evidence is not in electronic form then the item of evidence is first digitised into an evidence data file which is input into the system 1 via the input module 4.

For a new piece of evidence, an original evidence data file is input to the system 1 via the input module 4 which communicates the original evidence data file to the processor 2. The system 1 then processes the original evidence data file and generates a block for a blockchain based on the original evidence data file. In some embodiments, the block is generated by the processor 2. In other embodiments, the block is generated by the blockchain system 6.

The system 1 generates the block for the blockchain by combining data indicative of the evidence identifier which identifies the original evidence data file and the hash code which is computed from the original evidence data file. The blockchain system then stores the generated block as a new block in the blockchain. In this case, the block starts a new chain within the blockchain since it corresponds to an original evidence data file which is being imported into the system 1 for the first time.

The system 1 is configured to store the original evidence data file in the memory 3 in its original form. This enables the original evidence data file to be inspected at a later date.

In some embodiments, the system 1 does not store any part of the evidence data file in the blockchain. The block which is stored in the blockchain represents the evidence identifier and the hash code computed from the original evidence data file and the content of the original evidence data file is not derivable from this information.

The system 1 is further configured to perform at least one transformation operation on an evidence data file 5 when the evidence data file 5 is input into the system 1. In some embodiments, the transformation operation is dependent on the format of the evidence data file 5. For instance, in some embodiments, the system 1 is configured to determine if the evidence data file 5 is a PDF file and, if the evidence data file is not a PDF file, the system 1 is configured to perform a transformation operation to convert the evidence data file into a PDF file.

In some embodiments, the system 1 is configured to collate a plurality of evidence data files into a composite PDF file by performing one or more transformation operations to combine the plurality of evidence data files into one or more composite PDF files. This operation constitutes a further transformation operation which occurs within the system 1.

In some embodiments, the system 1 is configured to perform a transformation operation to paginate a composite PDF file by inserting page numbers onto the pages of the composite PDF file.

In some embodiments, the system 1 is configured to perform a transformation operation to generate an image file, such as a rasterised image file, from one or more pages of an evidence data file. In some embodiments, the system 1 generates both a low resolution image file and a higher resolution image file for each page of an evidence data file. The system 1 stores the high and low resolution image files in the memory 3.

In some embodiments, the system is configured to perform optical character recognition (OCR) on a document when the document is input to the system 1.

Referring now to FIG. 2 of the accompanying drawings, when the system 1 performs a transformation operation 9 on an evidence data file 5, the system 1 generates a transformed evidence data file 10. When the system 1 performs the transformation operation 9, the system 1 generates a new block 11 in a blockchain 12. The system 1 generates the new block 11 by combining at least some and preferably all of the following data:
Data indicative of a hash of a previous block 13 in the blockchain 12,
the evidence identifier of the transformed evidence data file 10,
a hash code computed from the transformed evidence data file 10,
data indicative of the transformation operation 9, and
a timestamp indicating the time at which the transformation operation 9 was performed.

In further embodiments, the system 1 also combines data indicative of the person or entity that performed or requested the transformation operation 9 into the block 11 which is stored in the blockchain 12.

The system 1 is configured to receive a plurality of evidence data files and to perform transformation operations on each evidence data file and to store the evidence data files and the transformed evidence data files in the memory 3. Each evidence data file and transformation operation is logged in the blockchain 12 so that the blockchain 12 provides an irrefutable record of the evidence data files which are being managed by the system 1 and all transformation operations performed on the evidence data files within the system 1.

Each transaction or block on the blockchain 12 will identify at least one and preferably all of the following:
1. The evidence identifier and the hash code of an evidence data file.
2. The evidence identifier and the hash code of the transformed evidence data file.
3. Data indicative of the transformation operation applied to the evidence data file to produce the transformed evidence data file.
4. Data indicative of the identity of the person or entity which performed or instructed the transformation operation.
5. A timestamp indicating when the transformation operation was performed.
6. Security information including, but not limited to, the IP address of the requester, the MAC code of the requester, instance identifier and location of the processor if the evidence data file is processed at a location which is remote from the system 1.

The data in the blockchain 12 provides an irrefutable chain of proof which can be consulted to determine what transformation operations have been performed on an evidence data file and to verify the authenticity of a transformed evidence data file.

If a user knows the evidence identifier and/or a hash code computed from an evidence data file, the user can search the blockchain 12 for the evidence identifier and/or the hash code. If the blockchain 12 includes a block with the identifier and the hash code then data in the blockchain confirms for certain that the evidence data file corresponds to an evidence data file which has been processed by the system 1 and that the evidence data file can be traced back to an original evidence data file that was input into the system 1. The user can therefore trust the evidence data file as being authentic since any tampering to the evidence data file would change the hash code of the evidence data file such that the hash code no longer matches a hash code in the blockchain 12.

Once the system 1 has received evidence data files, the system 1 can be used to display the evidence data files to a user via the client computing device 7. A user requests an item of evidence via the client computing device 7 which transmits a request to the processor 2. The processor 2 identifies the item of evidence based on the evidence identifier and transmits the evidence data file or a transformed evidence data file corresponding to the item of evidence to the client computing device 7. The client computing device 7 is configured to display the evidence on the screen 8.

The system 1 is configured such that when the system 1 receives a request from a user, the system 1 outputs at least part of the data in the blockchain 12 to enable the user to verify the authenticity of an evidence data file using the data in the blockchain.

In some embodiments, the system 1 is configured to display an authenticity indicator to a user on the display screen 8 simultaneously with an image of the requested evidence. In some embodiments, the system 1 is configured to transmit a low resolution image file to the client computing device 7 to minimise the data which must be transferred to the client computing device 7, and hence increase the speed at which a user can browse through pages of evidence. In some embodiments, the system 1 is configured to transmit the higher resolution image to the client computing device 7 in response to a user request so that the user can view the evidence data file at a higher resolution.

The authenticity indicator provides a confirmation to the user that the evidence displayed on the display screen 8 is authentic since the evidence is verified as being authentic by the data in the blockchain 12.

In some embodiments, the system is configured to allow the data behind the authenticity indicator to be obtained through a public Application Programming Interface (API) so that the data displayed on the display screen 8 can be confirmed to have been generated directly from the contents of a block on the blockchain 12. This allows a user to verify that the authenticity indicator displayed on the display screen 8 is truly reflective of the data on the blockchain and hence that no tampering has occurred prior to displaying the authenticity indicator on the display screen 8.

In some embodiments, the system 1 is configured to provide a copy of the blockchain 12 to another host system, such as a computer system that is managed by a justice ministry in a country. In these embodiments, the system is configured with an API which enables a user to access the data in the copy of the blockchain 12 directly. This enables a user to confirm that the data behind the authenticity indicator displayed on the display screen 8 is based on data on the blockchain 12.

The system 1 of some embodiments provides an efficient end-to-end system for managing evidence which enables a judge viewing evidence via the screen 8 of the client computing device 7 to fully trust that the evidence is authentic since any and all transformations to the evidence are logged in the blockchain.

Embodiments of the subject matter and the functional operations described herein can be implemented in digital electronic circuitry, or in computer software, firmware, or hardware, including the structures disclosed in this specification and their structural equivalents, or in combinations of one or more of them.

Some embodiments are implemented using one or more modules of computer program instructions encoded on a computer-readable medium for execution by, or to control the operation of, a data processing apparatus. The computer-readable medium can be a manufactured product, such as hard drive in a computer system or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The terms “computing device” and “data processing apparatus” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks.

To provide for interaction with a user, some embodiments are implemented on a computer or a mobile device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A mobile device can be any type of portable electronic device, including a cellular telephone, a Personal Digital Assistant (PDA), smartphone, tablet etc. The mobile device can comprise a display, a Global Positioning System (GPS) module, a Global Navigation Satellite System (GLONASS) module, a compass, one or more cameras and various other input/output (I/O) components.

When used in this specification and the claims, the term “comprises” and “comprising” and variations thereof mean that specified features, steps or integers and included. The terms are not to be interpreted to exclude the presence of other features, steps or compounds.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realising the invention in diverse forms thereof.

It is claimed:

1. A computer-implemented method for managing digital evidence using a blockchain, the method comprising:
receiving a user request to verify the authenticity of an evidence data file, the evidence data file being identified by:
an evidence identifier, and
a hash code computed from the evidence data file;
searching a blockchain for the evidence identifier, the blockchain having a block comprising data indicative of:
a hash of a previous block in the blockchain,
the evidence identifier,
the hash code computed from the evidence data file,
a transformation operation, which produces a transformed evidence data file in the form of an image file from at least part of the evidence data file which, when decoded and viewed on a display screen, represents the appearance of at least part of the evidence data file; and
a timestamp indicating the time at which the transformation operation was performed;
wherein, if the evidence identifier is found in the blockchain, outputting an authenticity indicator to the user to notify the user that the evidence data file is verified as authentic by the data in the blockchain;
decoding and displaying the image file in response to a request from the user; and
displaying an authenticity indicator to the user with the image file, the authenticity indicator being indicative of data in the blockchain to notify a user viewing the authenticity indicator that the image file is verified as authentic by the data in the blockchain.

2. The method of claim 1, wherein the method further comprises:
receiving a user request to access an evidence data file;
outputting the transformed evidence data file to the user, the transformed evidence data file being identified by the same evidence identifier as the evidence data file requested by the user; and
outputting the authenticity indicator to the user to verify the authenticity of the transformed evidence data file only if the evidence identifier is found the blockchain.

3. The method of claim 1, wherein the blockchain has a block comprising data indicative of a further transformation operation comprising:
determining if the evidence data file is a Portable Document Format (PDF) file and, if the evidence data file is not a PDF file, performing a transformation operation to convert the evidence data file into a PDF file;
collating the evidence data file with at least one further evidence data file to create a composite PDF file; and
paginating the composite PDF file by inserting page numbers onto the pages of the composite PDF file, wherein the composite PDF file is the transformed evidence data file.

4. The method of claim 1, wherein the block of the blockchain comprises data indicative of:
at least one of a person and an entity that requested the transformation operation.

5. The method of claim 4, wherein the block of the blockchain comprises data indicative of:
security information including the IP address of each person and each entity and the MAC code of each person and each entity.

6. The method of claim 1, wherein the block of the blockchain comprises data indicative of:
location data if the evidence data file is processed at a remote location.

7. The method of claim 1, wherein part of the data in the blockchain is accessible to the public and another part of the data in the blockchain is private and only accessible by authorised users and the method comprises:
permitting access to the blockchain if the user is authorised to access to the blockchain and preventing access the blockchain if the user is not authorised to access the blockchain.

8. The method of claim 1, wherein the method comprises:
receiving the image file at a first resolution at a client computing device to display the image file to the user and, in response to a further user request, receiving the image file at a second resolution at the client computing device to display the image file to the user, the second resolution being higher than the first resolution.

9. The method of claim 1, wherein the method comprises:
obtaining the authenticity indicator through a public Application Programming Interface (API).

10. A system for managing digital evidence using a blockchain, the system comprising:
a processor; and
a memory, the memory storing executable instructions which, when executed by the processor, cause the system to:
receive a user request to verify the authenticity of an evidence data file, the evidence data file being identified by:
an evidence identifier, and
a hash code computed from the evidence data file;
search a blockchain for the evidence identifier, the blockchain having a block comprising data indicative of:
a hash of a previous block in the blockchain,
the evidence identifier,
the hash code computed from the evidence data file,
a transformation operation, which produces a transformed evidence data file in the form of an image file from at least part of the evidence data file which,
when decoded and viewed on a display screen, represents the appearance of at least part of the evidence data file; and
a timestamp indicating the time at which the transformation operation was performed;
wherein, if the evidence identifier is found in the blockchain, the system outputs an authenticity indicator to the user to notify the user that the evidence data file is verified as authentic by the data in the blockchain;
decode and display the image file in response to a request from the user; and
display an authenticity indicator to the user with the image file, the authenticity indicator being indicative of data in the blockchain to notify a user viewing the authenticity indicator that the image file is verified as authentic by the data in the blockchain.

11. The system of claim 10, wherein the memory stores executable instructions which, when executed by the processor, cause the system to:
receive a user request to access an evidence data file;
output the transformed evidence data file to the user, the transformed evidence data file being identified by the same evidence identifier as the evidence data file requested by the user; and
output the authenticity indicator to the user to verify the authenticity of the transformed evidence data file only if the evidence identifier is found the blockchain.

12. The system of claim 10, wherein the blockchain has a block comprising data indicative of a further transformation operation comprising:
determining if the evidence data file is a Portable Document Format (PDF) file and, if the evidence data file is not a PDF file, performing a transformation operation to convert the evidence data file into a PDF file;
collating the evidence data file with at least one further evidence data file to create a composite PDF file; and
paginating the composite PDF file by inserting page numbers onto the pages of the composite PDF file, wherein the composite PDF file is the transformed evidence data file.

13. The system of claim 10, wherein the block of the blockchain comprises data indicative of:
at least one of a person and an entity that requested the transformation operation.

14. The system of claim 13, wherein the block of the blockchain comprises data indicative of:
security information including the IP address of each person and each entity and the MAC code of each person and each entity.

15. The system of claim 10, wherein the block of the blockchain comprises data indicative of:
location data if the evidence data file is processed at a remote location.

16. The system of claim 10, wherein part of the data in the blockchain is accessible to the public and another part of the data in the blockchain is private and only accessible by authorised users and the system permits access the blockchain if the user is authorised to access the blockchain and prevents access to the blockchain if the user is not authorised to access the blockchain.

17. The system of claim 10, wherein the system receives the image file at a first resolution at a client computing device to display the image file to the user and, in response to a further user request, receives the image file at a second resolution at the client computing device to display the image file to the user, the second resolution being higher than the first resolution.

18. The system of claim 10, wherein the system is configured to allow the authenticity indicator to be obtained through a public Application Programming Interface (API).

19. The system of claim 10, wherein the system comprises an Application Programming Interface (API) which enables a user to access data in a copy of the blockchain.
